(19) United States
(12) Patent Application Publication
(10) Pub. No.: US 2006/0156233 A1
(43) Pub. Date: Jul. 13, 2006

(54) Predictive text input

(75) Inventor: Mikko Nurmi, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/035,687

(22) Filed: Jan. 13, 2005

(51) Int. Cl. G06F 17/21; G06F 17/24; G06F 17/00

(52) U.S. Cl. 715/532; 715/534; 707/3

(57) ABSTRACT

The invention relates to an electronic text inputting for an electronic device comprising at least the steps of providing alphanumeric user input, searching words from at least one dictionary on the basis of the provided alphanumeric user input, providing the words resulting from the search to the user, wherein the at least one dictionary is formed based on words from at least one text piece acquired from a memory of the device, the at least one text piece being selected based on at least one person pertaining to the text. The invention relates to methods, to a device and to a computer program.

### FIELD OF THE INVENTION

This invention relates generally to typing and particularly to typing by means of predictive text input.

### BACKGROUND OF THE INVENTION

Electronic typing can be carried out by a keyboard that can be a general keyboard (e.g. QWERTY), where each letter has its own button, or a keyboard, where each button has a combination of letters. For example, one kind of a keypad for mobile terminal has eight buttons for letters, one for space and one for punctuation marks. The alphabets are divided to those eight buttons in such manner that each button comprises at least three letters and the number corresponding the button. The letters of each button can be browsed by pressing the button that many times the desired letter is presented.

Currently predictive text input has become popular and fast way to input text in communication devices comprising keyboard/keypad. One example of the predictive text input is so called T9™ software, that is used e.g. in mobile terminals. The advantage of the predictive text input, especially with keypads having “a contracted” keypad, is that the user can compose a word by pushing corresponding buttons once, whereby the predictive text input predicts a word composed of the letters/button combination in question. It can be seen that because each button has at least three letters, there can be several combinations that provides a real word. If the word is not the right one, the user may choose some other word from a dictionary that comprises most commonly-used words composed of the letters of the pushed buttons.

The dictionary is generally limited by default to the most commonly-used words. The user may however add new words, which are normally unrecognized by the dictionary, but still used by the user. The user may add new words by modifying the typed button string if the dictionary does not recognize the word during the prediction or if the word is not found from the prediction list. The user may also be aware, that some word does not absolutely exist in the dictionary, whereby he/she may insert a complete word by typing it.

Even though new words can be quite easily added to the dictionary, it is impossible to have all the needed words in the dictionary. Especially words like place-names, nicknames, slang or dialect words are such that are difficult to cover. The need for a solution that would provide an improved method for text input and for use of dictionary is noticed.

One solution for predicting text input is presented in US application US2003/0234821A1, wherein a string or word is found that is related to other portions of the message. In the publication, a letter sequence can be completed to a word regarding the last typed word or words of a text message which is already input by the user. According to this the text prediction is improved. In one embodiment the probability criterion is calculated with regard to a matching possibility of a following word sequence and dependent on at least one classification criterion assigned to the word sequence previously input as the text message. The probability criterion is provided by searching the words previously input for the text message in a dictionary and retrieving argument codes additionally stored in conjunction therewith.

However, what is needed, is a simpler solution for text prediction, which solution provides a fast and perceiving word dictionary offering along the commonly-used words also unrecognized words that relate to certain situation.

### SUMMARY OF THE INVENTION

Therefore it is an aim of this invention to provide a solution that relates to methods, to a device and to a computer program for an improved predictive text input.

One example of a method for electronic text inputting comprises steps of providing or receiving alphanumeric user input, searching words from at least one dictionary on the basis of the provided or received alphanumeric user input, providing the words resulting from the search to the user, wherein the at least one dictionary being formed based on words from at least one text piece acquired from a memory of the device, said at least one text piece being selected based on at least one person pertaining to the text.

In one example of a method for forming a dictionary usable in electronic text inputting, wherein at least one existing text piece is acquired, the at least one text piece being selected based on the at least one person pertaining to the text, and the words of said text piece not existing in a default dictionary are found, whereby these words are used for forming said dictionary.

One example of the device for electronic text inputting comprises means for providing or receiving alphanumeric user input, whereby the device is capable of searching words from at least one dictionary on the basis of the provided or received alphanumeric user input and providing the words resulting from the search to the user, which at least one dictionary comprises words from at least one text piece acquired from a memory of the device, said at least one text piece being based on at least one person pertaining to the text.

One example of the computer program for electronic text inputting comprises computer readable instructions for providing or receiving alphanumeric user input, searching words from at least one dictionary on the basis of the provided or received alphanumeric user input, providing the words resulting from the search to the user, wherein the at least one dictionary being formed based on words from at least one text piece acquired from a memory of the device, said at least one text piece being selected based on at least one person pertaining to the text.

The solution now discussed have considerable advantages compared to related art.

According to this solution the default dictionary is not loaded with rarely used words, but still these rarely used words can be offered to the user according to certain circumstances by means of the additional dictionary. The additional dictionary being utilized in predictive text input is composed specifically to each situation.

What should be noted is that the method according to the invention can be implemented in an application level, whereby the device does not require any new hardware components.

### DESCRIPTION OF THE DRAWINGS

The accompanying drawings, which are incorporated in and constitute a part of this specification, illustrate examples relating to the invention and, together with the description, explain the objects, advantages and principles of the invention. In the drawings

FIG. 1 illustrates an example of a communication device,

FIG. 2 illustrates an example of a structure of the communication device in very simplified manner,

FIGS. 3a and 3b illustrate method steps according to two examples.

### DETAILED DESCRIPTION OF THE INVENTION

Although specific terms are used in the following description for the sake of clarity, these terms are intended to refer only to the particular structure of the invention selected for illustration in the drawings and are not intended to define or limit the scope of the invention. The invention relates to predictive text input in electronic communication devices. Text inputting can be implemented in different ways and the solution now discussed is also usable among them. The solution is not targeted to any particular keyboard or text inputting system, but is aimed to facilitate and facilitate the actual text input operation. In the description a general term “keyboard” is used, but it should be understood that other text inputting systems, e.g. a mobile keypad, a PDA virtual keypad or a stylus, or any device capable of providing alphanumeric input in one form or another can benefit from the invention. The term “default dictionary” refers to a built-in dictionary that comprises words stored by default (usually the most common words of the language in question). The default dictionary may be modified by the user. Term “additional dictionary” refers to a dictionary that is formed according to this invention. It should be noted that the amount of additional dictionaries is not limited into one. Similarly, in some situations it is possible to include the additional dictionary as a part of the default dictionary.

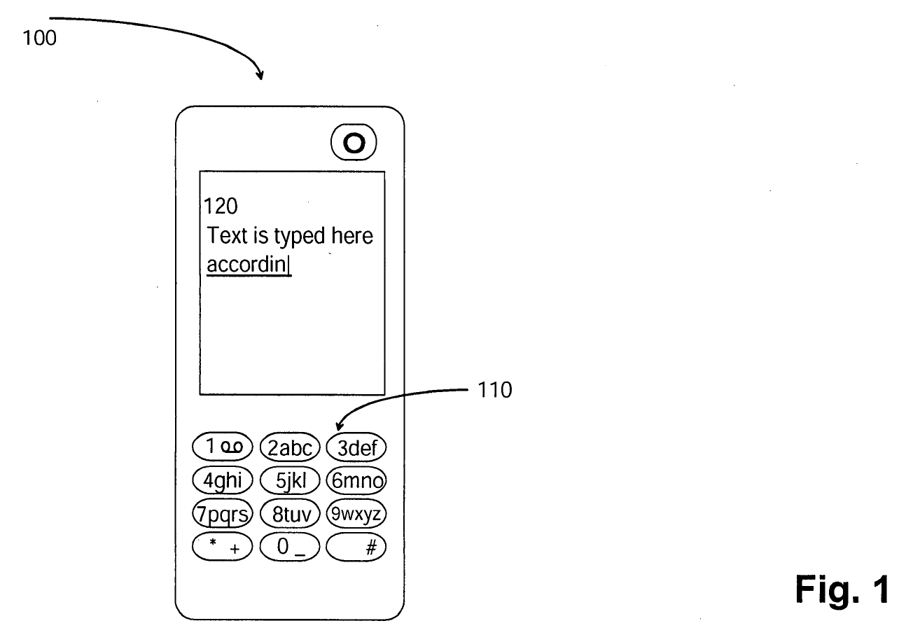

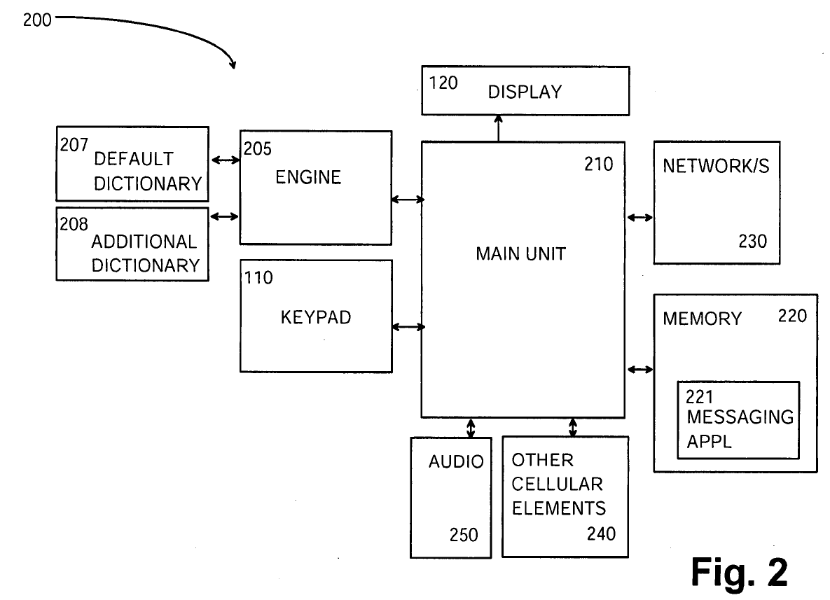

One example of the device is illustrated in FIG. 1. The device is a mobile terminal 100 that comprises a keypad 110 and a display 120. The keypad 110 is a number keypad, wherein the numbers from two to eight comprises also letter signs. According to input selections in the keypad 110, the user may produce text, which can be seen on a display 120. With this kind of a keypad, the keypad buttons are expected to be pushed only once for each letter in the word. The predictive text input is then capable of composing words of the letters from the buttons being pushed. FIG. 2 illustrates the device as a simplified block diagram. For carrying out the predictive text input, the device comprises an engine 205 that matches the button selections of a keypad 110 to a default dictionary 207 and offers commonly-used words to the user. The default dictionary 207 is a built-in word database in the device 200.

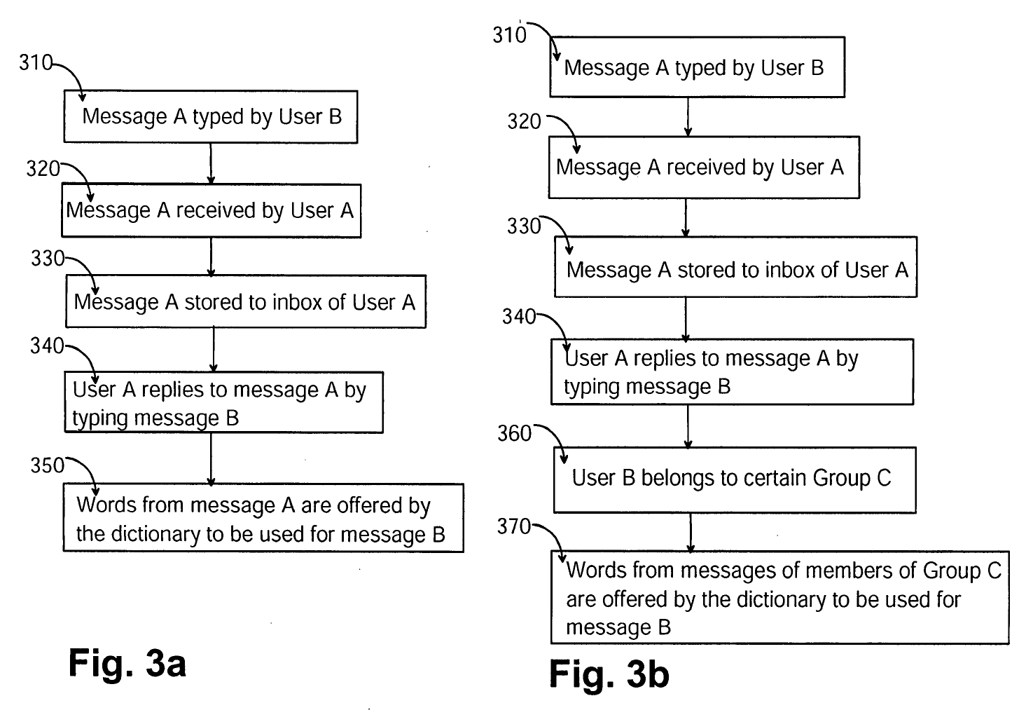

As said, the default dictionary 207 comprises commonly-used words that are stored by default. The user may, at any point, modify the dictionary by adding new words thereto. The predictive text input according to this invention may also operate with one or more additional dictionaries 208 that may be automatically formed by words existing in the device's memory 220. The additional dictionary 208 may also form a part of the word database in the device 200. For example, in this example, the additional dictionary 208 is formed of words that are found from a messaging application 221. This feature will be now discussed with a following example and the reference is made to FIGS. 3a, 3b.

In FIG. 3a User A receives (320) a message A (typed in English in this example) from User B. Message A comprises text: “Ciao, r u coming tonite? Take the beemer and drive to address 24 Gooseroad. Can u bring some takeout?” Message A is stored (330) to the device of User A. User A wants to communicate to User B that he cannot take the car and he don't know the address: “Ciao, tonite is fine. My wife has the beemer & she can drive me. Where is Gooseroad? What kind of takeout you want, a pizza?” User A types the reply message B (340) by means of predictive text engine. In this example the predictive text engine does not recognize the combination of buttons “2-4-2-6” for “ciao”, “2-3-3-6-3-7” for “beemer” as well as words “tonite”, “Gooseroad” and “takeout” and does not find them from the default dictionary. However, in this example the predictive text engine is configured to utilize the words from the message A (the one that is replied to) (350) by forming an additional dictionary of the words therein. Due to this, a total dictionary performance is increased. Now, when the predictive text engine notices the combination of buttons, it is capable of offering also the “odd” words from the additional dictionary comprising words from earlier message A.

The idea of this invention as seen from the previous example: the dictionary performance can be increased because of words from a piece of text or “text piece” in the memory of the device. However the implementation can be carried out in various ways. Few of the examples are described next.

Whereas in the previous example the additional dictionary was formed of words from the message that was replied to, in this example the additional dictionary is formed of words from messages sent by a certain sender. For example, the predictive text engine notices that message inbox has several messages from user “Jack”. When User A is replying to one of Jack's messages, the additional dictionary is automatically supplied with words from all or few of Jack's latest messages. It is clear that two or more persons may have specific interests, typical meeting places or shared friends, whereby the communication between them may often relate to those subjects. According to this example, the additional dictionary may offer “odd words” that, however, are typical words between said persons.

Similarly, as in presented in FIG. 3b, if a sender belongs to some certain group, words from messages of each group member can be used forming the additional dictionary. Therefore, when User A is replying to cousin Jack (user B), who belongs to group “Relatives” (Group C), the predictive text engine may use also words from messages sent by other users assigned to the same group.

It is to be understood that there may be more than one or a plurality of additional dictionaries in use at the same time. A situation, in which this may happen could be that the user is writing a reply to a message from a person, which pertains to one or more groups. In this exemplary situation, the additional dictionary may be formed on the basis of the group or groups, in which the person is associated, or on the basis of the message or messages from the person the user is replying to, or on the basis of the messages the user has sent to a person or to persons assigned to a same group earlier, or any combination of these. Also the priority, i.e. from which additional dictionary the word respective to a certain combination of alphanumeric input is searched first, between additional or the plurality of additional dictionaries and the default dictionary may vary according to embodiments of the invention.

What should be noted here is that the predictive text engine may use any message that is stored on the device, but also any other text file stored on the device (e.g. text in contact information, stored network addresses). For example, the text engine may use words from “Sent messages” box, whereby the words a user such as User A has used are offered by the dictionary. The method disclosed here is applicable with text messages (e.g. SMS), but also with emails and with other text inputting, where predictive text input is possible. Examples of other text inputs are instant messages, wherein the previous messages can be used as a word source for the dictionary, and chat communications, wherein a current chat session or former chat sessions can be used as the word source. The main idea is to use existing pieces of text for forming an additional dictionary and therefore completing the word selection of the default dictionary. After the piece of text is finalized the additional dictionary may be saved, unloaded or deleted.

In the previous example an additional dictionary is formed of existing words. The additional dictionary can be considered as a dynamical dictionary that can easily be removed after usage. It is also possible to include the additional dictionary to the default dictionary, but it should be evident that in that case the default dictionary would be more loaded. Because usually additional words relate only to certain communication situations it is desired to maintain the performance of daily usable dictionary (i.e. default dictionary). As said earlier, the amount of the additional dictionaries may vary. For example, depending on the situation, there can be several dictionaries e.g. one for words of sent messages, one for words of received messages, one for words of received messages from “Jack” etc. These additional dictionaries can offer words from the last predetermined number of messages. If many additional dictionaries with different characteristics are used, it is possible mark the words with metadata, whereby words with certain features can be selected. For example in addition to the default dictionary, the device may comprise a selection of additional dictionaries that are formed according to the user's setting selections.

The additional dictionary can be formed for use almost at any phase of text inputting. For example, the additional dictionary can be formed at the time the user begins to input text to e.g. the message. The additional dictionary can also be formed instantly at a time the engine cannot find words relating to the button combination from the default dictionary. The additional dictionary can be stored in compressed form for saving storage space.

The device according to this invention can comprise other means as well. See for example FIG. 2, wherein the device comprises audio means 250 and cellular elements 240 that can be utilized in mobile communication. Also the device in this example comprises one or many networking capabilities 230 for receiving and sending communications. It should be noticed that FIG. 2 is an example, whereby it will be appreciated that the predictive text input discussed here is not limited only to this kind of device but can be used with devices e.g. without network connections.

It will be clear that variations and modifications of examples now discussed are possible without departing from the scope of protection of the invention as set forth in the claims.

We claim:

1. Electronic text inputting method for an electronic device comprising at least the steps of
providing alphanumeric user input,
searching words from at least one dictionary based on the alphanumeric input of a user,
providing words resulting from the searching to the user,
the at least one dictionary being formed based on words from at least one text piece acquired from a memory of the device, said at least one text piece being selected based on at least one person pertaining to the text piece.

2. The method according to claim 1, wherein the at least one dictionary is formed of at least one text piece from at least one of the group of: short message, email, multimedia message and chat-related text.

3. The method according to claim 1, wherein the at least one dictionary is formed of words from a message, which is replied to.

4. The method according to claim 1, wherein the at least one dictionary is formed of words from at least one sent message.

5. The method according to claim 1, wherein the at least one dictionary is formed of words from at least one message that is identified by a certain metadata.

6. The method according to claim 1, wherein the at least one dictionary is formed of words from at least one message that is identified by an associated person.

7. The method according to claim 1, wherein said text piece is from the following group: short message, email, multimedia message or chat related.

8. A method for forming a dictionary usable in electronic text inputting comprising selecting at least one existing text piece, the at least one text piece selected based on at least one person pertaining to the text piece, and words of said text piece not existing in a default dictionary are found, and using these words for forming said dictionary.

9. Device for electronic text inputting comprising means for providing alphanumeric user input, wherein the device is capable of searching words from at least one dictionary based on the alphanumeric user input and means for providing the words resulting from a search to the user, which at least one dictionary comprises words from at least one text piece acquired from a memory of the device, said at least one text piece based on at least one person pertaining to the text piece.

10. The device according to claim 9, being capable of forming the least one dictionary at a time the electronic text inputting is begun.

11. The device according to claim 9, wherein the at least one dictionary comprises words from at least one text piece of the following group: short message, email, multimedia message or chat related.

12. The device according to claim 9, wherein the at least one dictionary comprises words from a message, which is replied to.

13. The device according to claim 9, wherein the at least one dictionary comprises words from at least one sent message.

14. The device according to claim 9, wherein the at least one dictionary comprises words from at least one message identified by a certain metadata.

15. The device according to claim 14, wherein the at least one dictionary comprises words from at least one message identified by a certain person.

16. The device according to claim 9, wherein a text inputting is of text from the following group: short message, email, multimedia message or chat communication.

17. The device according to claim 9, comprising communication means.

18. A computer program for electronic text inputting comprising computer readable instructions for
providing alphanumeric user input,
searching words from at least one dictionary based on the alphanumeric input of a user,
providing words resulting from the searching to the user,
the at least one dictionary being formed based on words from at least one text piece acquired from a memory of the device, said at least one text piece being selected based on at least one person pertaining to the text piece.

19. The computer program according to claim 18, configured to form the at least one dictionary at a time the electronic text inputting is begun.

20. The method according to claim 1, wherein said text inputting is of text from the following group: short message, email, multimedia message or chat related.
